(19) United States
(12) Patent Application Publication
(10) Pub. No.: US 2011/0277940 A1
(43) Pub. Date: Nov. 17, 2011

(54) Air Sealing Device for bag

(76) Inventor: Sung-Po Tsai, Sihu Township (TW)

(21) Appl. No.: 12/780,009

(22) Filed: May 14, 2010

(51) Int. Cl. B29C 65/78

(52) U.S. Cl. 156/538

(57) ABSTRACT

An air sealing device includes a holding unit and an outer clamp mounted on the holding unit to clamp the holding unit. The holding unit includes a first clamping bar and a second clamping bar pivotally connected with the first clamping bar. The holding unit has a clamping space defined between the first clamping bar and the second clamping bar. Thus, the opened upper end of the bag is clamped in the clamping space of the holding unit, wound around the first clamping bar and the second clamping bar of the holding unit and pressed by the outer clamp so that the opened upper end of the bag is sealed by the holding unit and the outer clamp closely and tightly.

### BACKGROUND OF THE INVENTION

1. Field of the Invention

The present invention relates to a sealing device and, more particularly, to an air sealing device for a bag.

2. Description of the Related Art

A conventional air sealing device for a bag in accordance with the prior art shown in FIG. 8 comprises a holding bar 5 having an end portion provided with an enlarged head 51 and an outer clamp 4 mounted on the holding bar 5 and having a lower portion formed with a pressing slit 41 pressing the holding bar 5. When in use, a bag has an opened upper end wound around the holding bar 5 and stopped by the head 51 of the holding bar 5. Then, when the outer clamp 4 is moved toward the holding bar 5, the holding bar 5 is inserted into the outer clamp 4 so that the outer clamp 4 is locked onto the holding bar 5 to clamp the opened upper end of the bag between the outer clamp 4 and the holding bar 5. Thus, the opened upper end of the bag is clamped between the outer clamp 4 and the holding bar 5 so that the opened upper end of the bag is, sealed. However, the opened upper end of the bag is only pressed by the pressing slit 41 of the outer clamp 4 so that the opened upper end of the bag is not clamped between the outer clamp 4 and the holding bar 5 closely and tightly, thereby decreasing the sealing effect.

The closest prior art reference of which the applicant is aware was disclosed in U.S. Pat. No. 5,921,601. In the above-mentioned prior art reference, the groin 17 is formed with arms 12, 14 and 16, and open slots 18 and 20 are formed between the arms 12, 14 and 16. A ring 22 is mounted on the arm 16. The ring 22 is snapped into a recess 23 of the arm 12. Projections 24 and 26 are formed on the arms 12 and 16 and are locked in holes of the arm 14. Thus, the open end of the bag extends through the open slot 18, passes through the arm 14 and extends outward from the open slot 20, and is snapped onto the ring 22 and the recess 23 to seal the bag. However, it is necessary to have a determined distance between the open slots 18 and 20 so that the bag can be snapped onto the ring 22 and the recess 23. Thus, when the content of the bag has a heavier weight, the open slots 18 and 20 cannot bear the weight of the bag so that the bag easily slips outward from the open slots 18 and 20 due to the excessive weight of the bag.

### BRIEF SUMMARY OF THE INVENTION

In accordance with the present invention, there is provided an air sealing device, comprising a holding unit and an outer clamp mounted on the holding unit to clamp the holding unit. The holding unit includes a first clamping bar and a second clamping bar pivotally connected with the first clamping bar. The holding unit has a clamping space defined between the first clamping bar and the second clamping bar.

The primary objective of the present invention is to provide an air sealing device having an excellent sealing effect.

According to the primary objective of the present invention, the opened upper end of the bag is clamped in the clamping space of the holding unit, wound around the first clamping bar and the second clamping bar of the holding unit and pressed by the outer clamp so that the opened upper end of the bag is sealed by the holding unit and the outer clamp closely and tightly to have an excellent air-tight sealing effect.

According to another objective of the present invention, the insert of the first clamping bar is inserted into the mounting hole of the second clamping bar so that the first clamping bar and the second clamping bar of the holding unit are combined together solidly and tightly so as to seal the opened upper end of the bag closely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an air sealing device in accordance with the preferred embodiment of the present invention.

FIG. 2 is a side cross-sectional view of the air sealing device as shown in FIG. 1.

FIG. 3 is a partially exploded perspective view of the air sealing device as shown in FIG. 1.

FIG. 4 is a perspective view of a holding unit of the air sealing device as shown in FIG. 1.

FIG. 5 is a partially side cross-sectional view of the air sealing device as shown in FIG. 1.

FIG. 6 is a perspective view of a holding unit of the air sealing device in accordance with another preferred embodiment of the present invention.

FIG. 7 is a side cross-sectional view of the air sealing device in accordance with a further preferred embodiment of the present invention.

FIG. 8 is an exploded perspective view of a conventional air sealing device in accordance with the prior art.

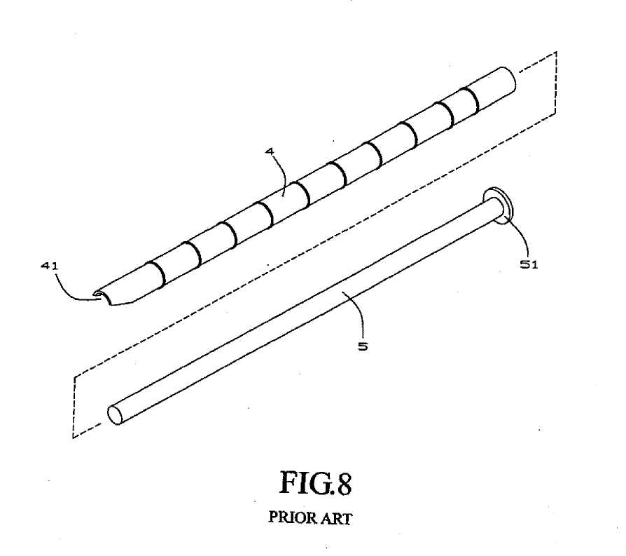

### DETAILED DESCRIPTION OF THE INVENTION

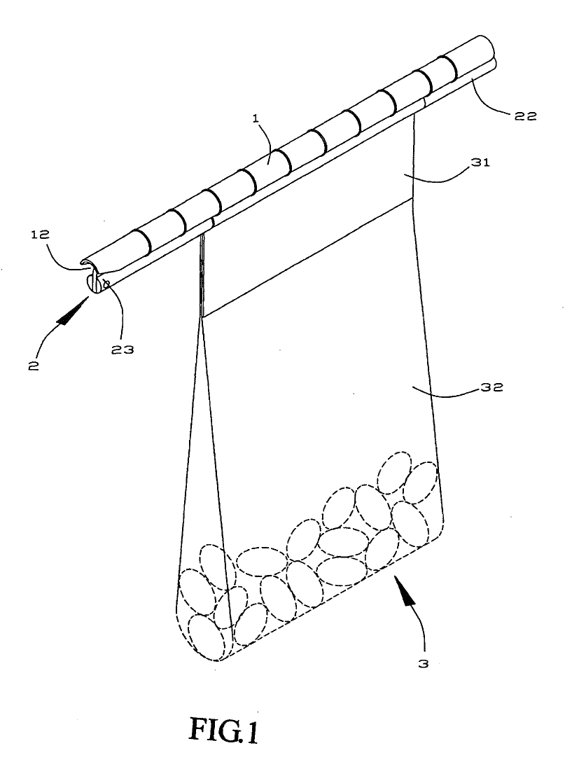

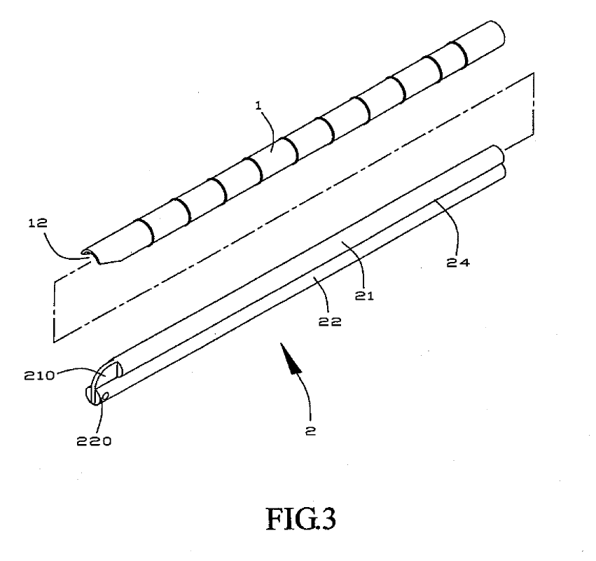

Referring to the drawings and initially to FIGS. 1-5, an air sealing device in accordance with the preferred embodiment of the present invention comprises a holding unit 2 and an outer clamp 1 mounted on the holding unit 2 to clamp the holding unit 2.

The holding unit 2 includes a first clamping bar 21 and a second clamping bar 22 pivotally connected with the first clamping bar 21. The holding unit 2 has a clamping space 24 defined between the first clamping bar 21 and the second clamping bar 22. The first clamping bar 21 of the holding unit 2 has a first end formed with a first pivot portion 210 and a second end formed with an insert 211. The first clamping bar 21 of the holding unit 2 has a substantially circular cross-sectional profile. The second clamping bar 22 of the holding unit 2 has a first end formed with a second pivot portion 220 pivotally connected with the first pivot portion 210 of the first clamping bar 21 and a second end formed with a mounting hole 221 to allow insertion of the insert 211 of the first clamping bar 21. The second clamping bar 22 of the holding unit 2 has a substantially circular cross-sectional profile and has a diameter equal to that of the first clamping bar 21 of the holding unit 2.

The outer clamp 1 is mounted on the first clamping bar 21 of the holding unit 2 and has an inner wall 10 surrounding the first clamping bar 21 of the holding unit 2. The outer clamp 1 has a substantially C-shaped cross-sectional profile and has a lower portion formed with an elongate pressing slit 11. The pressing slit 11 of the outer clamp 1 has an end formed with an entrance 12 to allow entrance of the first clamping bar 21 of the holding unit 2. The pressing slit 11 of the outer clamp 1 is disposed between the first clamping bar 21 and the second clamping bar 22 of the holding unit 2 and is connected to the clamping space 24 of the holding unit 2.

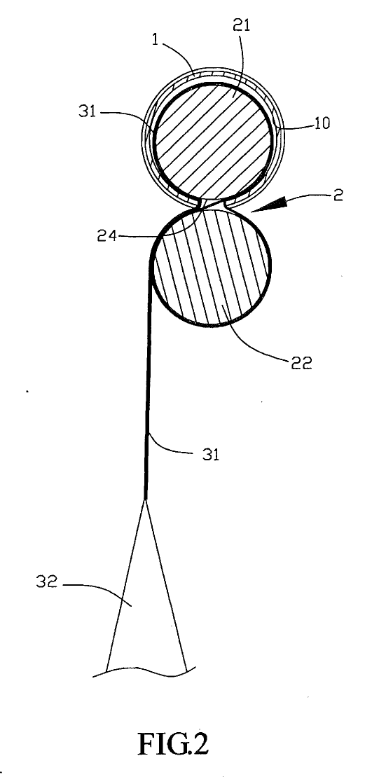

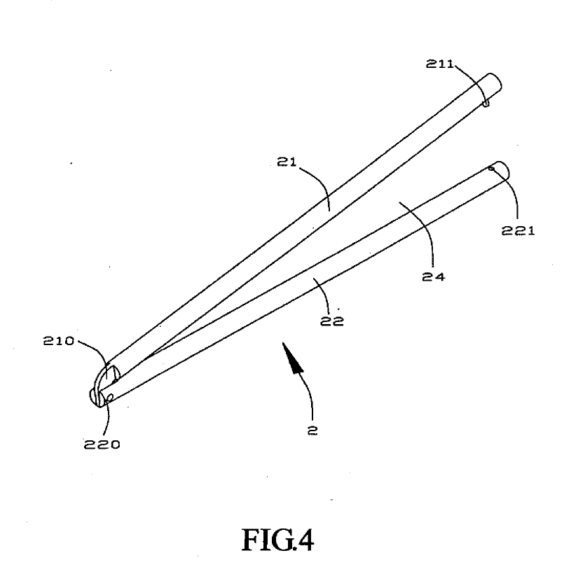

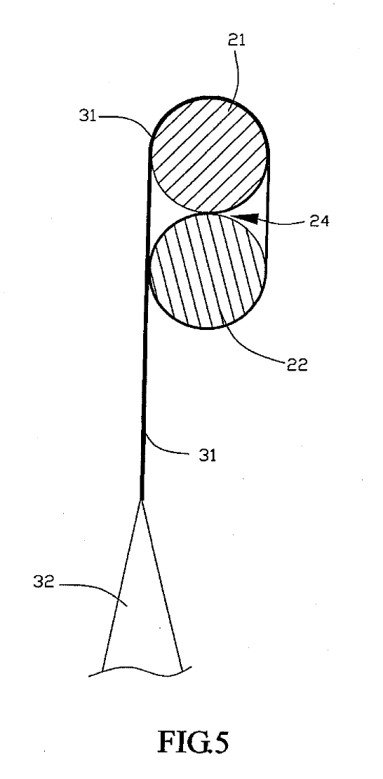

When in use, the clamping space 24 of the holding unit 2 is opened as shown in FIG. 4 to allow passage of an opened upper end 31 of a bag 32. Then, the first clamping bar 21 and the second clamping bar 22 of the holding unit 2 are pivoted and moved toward each other to close the clamping space 24 of the holding unit 2 so that the opened upper end 31 of the bag 32 is clamped in the clamping space 24 of the holding unit 2 and located between the first clamping bar 21 and the second clamping bar 22 of the holding unit 2. At this time, the insert 211 of the first clamping bar 21 is inserted into the mounting hole 221 of the second clamping bar 22 so that the first clamping bar 21 and the second clamping bar 22 of the holding unit 2 are combined together. Then, the holding unit 2 is rotated to wind the opened upper end 31 of the bag 32 around the first clamping bar 21 and the second clamping bar 22 of the holding unit 2 as shown in FIG. 5. Then, when the outer clamp 1 is moved toward the first clamping bar 21 of the holding unit 2, the first clamping bar 21 of the holding unit 2 is inserted through the entrance 12 of the outer clamp 1 into the outer clamp 1 so that the outer clamp 1 is locked onto the first clamping bar 21 of the holding unit 2 as shown in FIGS. 1 and 2 to compress the opened upper end 31 of the bag 32 onto the first clamping bar 21 and the second clamping bar 22 of the holding unit 2 by the pressing slit 11 of the outer clamp 1.

In such a manner, the opened upper end 31 of the bag 32 is clamped in the clamping space 24 of the holding unit 2, wound around the first clamping bar 21 and the second clamping bar 22 of the holding unit 2 and pressed by the outer clamp 1 so that the opened upper end 31 of the bag 32 is sealed by the holding unit 2 and the outer clamp 1 closely and tightly without incurring a leakage.

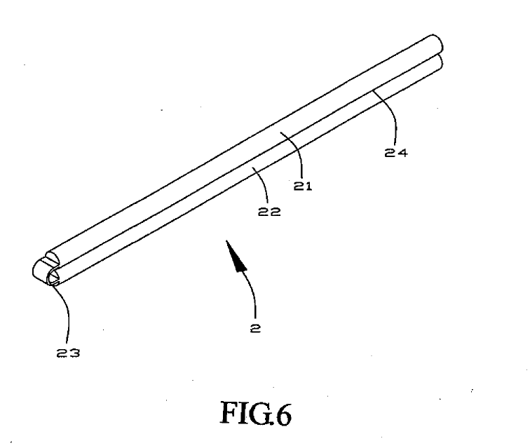

As shown in FIG. 6, the holding unit 2 further includes a pivot member 23 pivotally mounted between the first clamping bar 21 and the second clamping bar 22 so that the first clamping bar 21 and the second clamping bar 22 are pivotable about the pivot member 23. Preferably, the pivot member 23 of the holding unit 2 is integrally formed on the first clamping bar 21 and the second clamping bar 22.

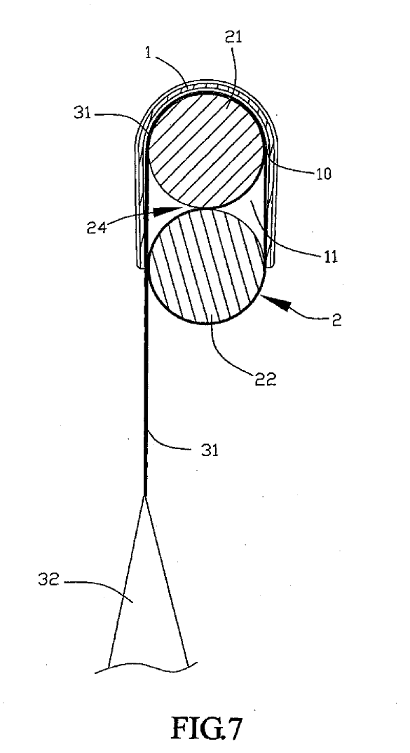

As shown in FIG. 7, the outer clamp 1 is mounted on the first clamping bar 21 and the second clamping bar 22 of the holding unit 2 and has an inner wall 10 surrounding the first clamping bar 21 and the second clamping bar 22 of the holding unit 2. The first clamping bar 21 of the holding unit 2 is hilly surrounded by the outer clamp 1, and the second clamping bar 22 of the holding unit 2 is partially surrounded by and partially protruded outwardly from the outer clamp 1. The outer clamp 1 has a substantially inverted U-shaped cross-sectional profile and has a lower portion formed with an elongate pressing slit 11. The pressing slit 11 of the outer clamp 1 presses the second clamping bar 22 of the holding unit 2.

Accordingly, the opened upper end 31 of the bag 32 is clamped in the clamping space 24 of the holding unit 2, wound around the first clamping bar 21 and the second clamping bar 22 of the holding unit 2 and pressed by the outer clamp 1 so that the opened upper end 31 of the bag 32 is sealed by the holding unit 2 and the outer clamp 1 closely and tightly to have an excellent air-tight sealing effect. In addition, the insert 211 of the first clamping bar 21 is inserted into the mounting hole 221 of the second clamping bar 22 so that the first clamping bar 21 and the second clamping bar 22 of the holding unit 2 are combined together solidly and tightly so as to seal the opened upper end 31 of the bag 32 closely.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An air sealing device, comprising:
a holding unit; and
an outer clamp mounted on the holding unit to clamp the holding unit;
wherein the holding unit includes:
a first clamping bar; and
a second clamping bar pivotally connected with the first clamping bar;
the holding unit has a clamping space defined between the first clamping bar and the second clamping bar.

2. The air sealing device of claim 1, wherein
the first clamping bar of the holding unit has a first end formed with a first pivot portion;
the second clamping bar of the holding unit has a first end formed with a second pivot portion pivotally connected with the first pivot portion of the first clamping bar.

3. The air sealing device of claim 2, wherein
the first clamping bar of the holding unit has a second end formed with an insert;
the second clamping bar of the holding unit has a second end formed with a mounting hole to allow insertion of the insert of the first clamping bar.

4. The air sealing device of claim 1, wherein
the first clamping bar of the holding unit has a substantially circular cross-sectional profile;
the second clamping bar of the holding unit has a substantially circular cross-sectional profile.

5. The air sealing device of claim 4, wherein the second clamping bar of the holding unit has a diameter equal to that of the first clamping bar of the holding unit.

6. The air sealing device of claim 1, wherein the outer clamp has a lower portion formed with an elongate pressing slit.

7. The air sealing device of claim 6, wherein the outer clamp is mounted on the first clamping bar of the holding unit.

8. The air sealing device of claim 7, wherein the outer clamp has an inner wall surrounding the first clamping bar of the holding unit.

9. The air sealing device of claim 7, wherein the outer clamp has a substantially C-shaped cross-sectional profile.

10. The air sealing device of claim 6, wherein the pressing slit of the outer clamp is disposed between the first clamping bar and the second clamping bar of the holding unit.

11. The air sealing device of claim 10, wherein the pressing slit of the outer clamp is connected to the clamping space of the holding unit.

12. The air sealing device of claim 1, wherein the holding unit further includes:
a pivot member pivotally mounted between the first clamping bar and the second clamping bar so that the first clamping bar and the second clamping bar are pivotable about the pivot member.

13. The air sealing device of claim 12, wherein the pivot member of the holding unit is integrally formed on the first clamping bar and the second clamping bar.

14. The air sealing device of claim 6, wherein the outer clamp is mounted on the first clamping bar and the second clamping bar of the holding unit.

15. The air sealing device of claim 14, wherein the outer clamp has an inner wall surrounding the first clamping bar and the second clamping bar of the holding unit.

16. The air sealing device of claim 15, wherein the first clamping bar of the holding unit is fully surrounded by the outer clamp; and
the second clamping bar of the holding unit is partially surrounded by and partially protruded outwardly from the outer clamp.

17. The air sealing device of claim 14, wherein the outer clamp has a substantially inverted U-shaped cross-sectional profile.

18. The air sealing device of claim 14, wherein the pressing slit of the outer clamp presses the second clamping bar of the holding unit.
